(19) United States
(12) Patent Application Publication
(10) Pub. No.: US 2012/0087803 A1
(43) Pub. Date: Apr. 12, 2012

(54) CURVED FILM COOLING HOLES FOR TURBINE AIRFOIL AND RELATED METHOD

(75) Inventors: Jesse Blair BUTLER, Greenville, SC (US); Benjamin LACY, Greer, SC (US)

(73) Assignee: GENERAL ELECTRIC COMPANY, Schenectady, NY (US)

(21) Appl. No.: 12/902,517

(22) Filed: Oct. 12, 2010

(51) Int. Cl. F01D 5/18; B23P 15/02

(52) U.S. Cl. 416/97 R; 29/889.721

(57) ABSTRACT

A turbine bucket includes an airfoil portion at one end thereof; a root portion at an opposite end thereof; a platform portion between the airfoil portion and the root portion; at least one internal cavity within or radially inward of the platform portion having at least one film cooling hole extending between the at least one cavity and an external surface of the platform portion. The film cooling hole is curved along a length dimension of the film cooling hole.

This invention relates generally to gas turbine airfoil technology and, more specifically, to film cooling of the platform portion of an airfoil.

### BACKGROUND OF THE INVENTION

Film cooling holes are typically drilled into the platform portion of a gas turbine airfoil using a traditional straight or linear drill bit, oriented at a uniform shallow angle of approximately 30° relative to the surface of the platform. Holes drilled at an angle in excess of 30° will likely result in degraded film cooling performance. This constraint can lead to difficulty when attempting to drill into an internal platform cavity. For example, when worst-case casting core float and positional tolerances are considered, the edge of the drill bit may partially or completely miss the target cavity and continue on into the bucket shank or root portion. To alleviate the problem, the hole angle must be increased which, as already noted, has negative performance implications, or the hole must be moved closer to the slash face of the airfoil platform. Positioning the hole closer to the slash face, however, may limit part life by reducing the area benefited by film cooling and by introducing stress concentrations in an already life-challenged region.

It would therefore be desirable to develop a technique that maintains the preferred film cooling hole angle but that eliminates problems relating to traditional manufacturing process capability.

### BRIEF SUMMARY OF THE INVENTION

In accordance with an exemplary but nonlimiting embodiment, the present invention provides a turbine bucket comprising an airfoil portion at one end thereof; a root portion at an opposite end thereof; a platform portion between the airfoil portion and the root portion; at least one internal cavity within or radially inward of the platform portion having at least one film cooling hole extending between the at least one internal cavity and an external surface of the platform portion, the at least one film cooling hole being curved along a length dimension of the at least one film cooling hole.

In another aspect, the invention relates to a turbine component comprising an external surface adapted to be cooled by film cooling air; an internal cavity within the turbine component adapted to supply film cooling air to the external surface; and at least one film cooling hole extending substantially radially between the internal cavity and the external surface, the at least one film cooling hole being curved along a length dimension of the at least one film cooling hole, wherein the at least one film cooling hole opens along a surface of the external surface at an angle of less than about 30° relative to the external surface, and wherein the at least one film cooling hole opens along a surface of the internal cavity at an angle greater than about 30° relative to the surface of the internal cavity.

In still another aspect, the invention relates a method of forming a film cooling hole in a turbine bucket platform connecting an external surface of the platform to an internal cavity within or radially inward of the platform comprising (a) locating a film cooling hole exit point on an exterior surface of the platform and a film cooling hole entry point opening into the internal cavity; and (b) drilling the film cooling hole to follow a curved path between the film cooling hole exit point and the film cooling hole entry point.

The invention will now be described in greater detail in connection with the drawings identified below.

### BRIEF DESCRIPTION OF THE DRAWINGS

FIG. 1 is a perspective view of a gas turbine bucket construction;

FIG. 2 is a partial section taken through a bucket platform illustrating straight film cooling holes and potential hole location problems; and

FIG. 3 is a section similar to FIG. 2, but illustrating a curved film cooling hole in accordance with an exemplary but non-limiting embodiment of the invention.

### DETAILED DESCRIPTION OF THE DRAWINGS

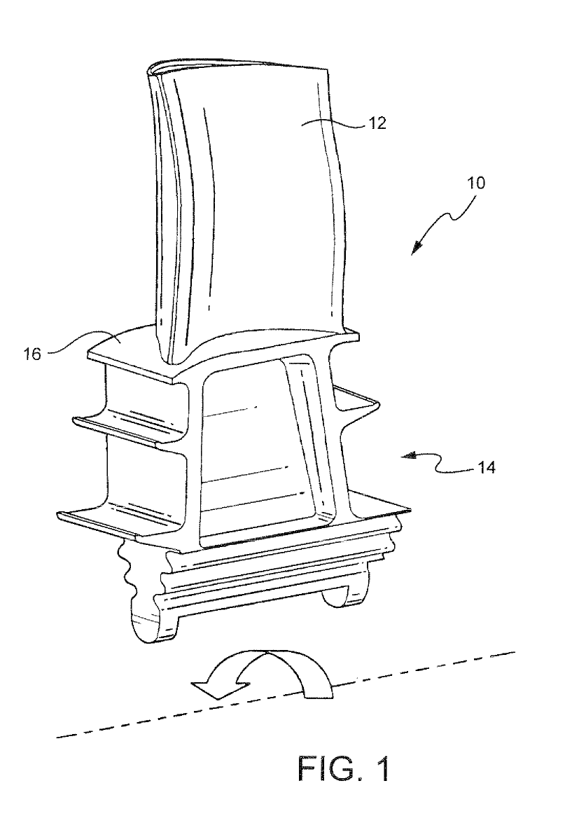

Referring initially to FIG. 1, there is illustrated a gas turbine airfoil or bucket 10 of known construction. The bucket includes an airfoil portion 12 and a bucket shank or root portion 14. A substantially flat platform portion (or simply, platform) 16 is located at an interface between the airfoil portion 12 and the root portion 14. Slash faces 17 (one shown) extend along opposite circumferential edges of the bucket.

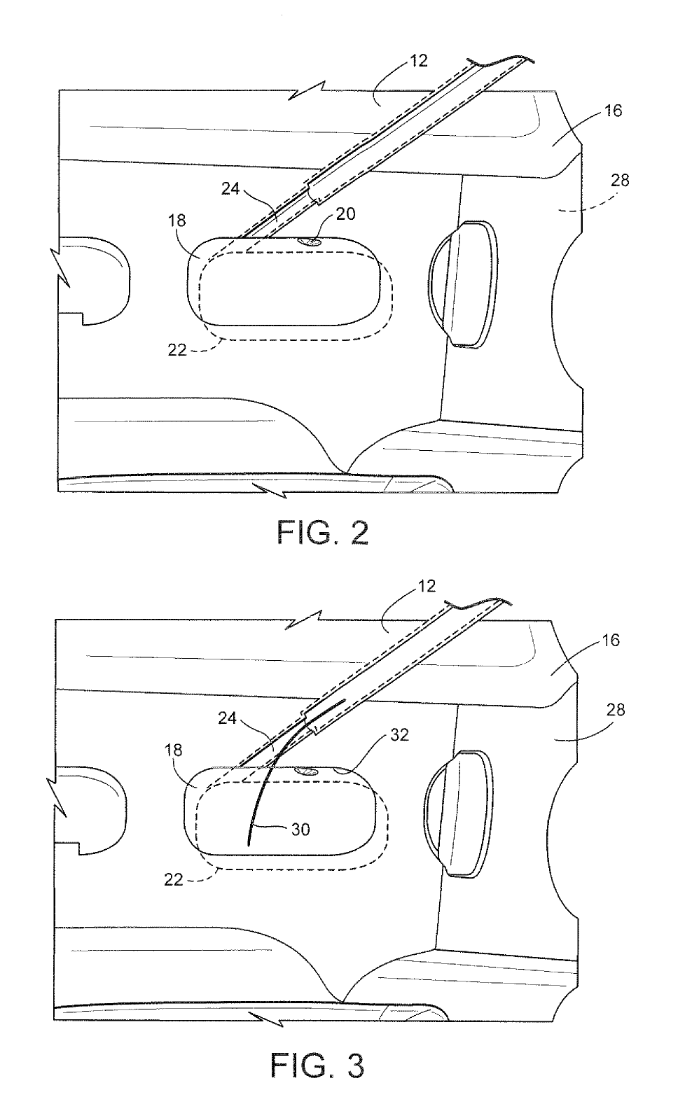

With reference now to FIG. 2, a cooling media such as cooling steam or air is typically supplied from a bucket or blade cooling circuit or from a platform cooling circuit (not shown) to one or more cavities 18 that have been for example, cast or machined within or radially inward of the platform 16. The coolant is supplied to the cavity 18 through one or more passages or bores connecting the cavities to an internal airfoil cooling circuit (not shown). Some portion of the cooling air or steam may exit the one or more cavities 18 by way of film cooling holes 20 that extend between the cavity 18 and the platform 16 on the suction side of the airfoil portion 12. The steam or air that exits the film cooling holes 20 generates a layer of cool air on the external surface of the platform 16 which further insulates the platform suction side from the hot gas path air.

The present invention relates to an improved technique for forming the platform film cooling holes 20, but it is to be understood that the invention is not limited to any particular cooling circuit design for either the platform or the airfoil (or any other component), and is applicable in any situation where film cooling holes are employed and where the benefits of curved film cooling holes may be realized.

With continued reference to FIG. 2, a typical film cooling 20 hole is drilled straight into the platform 16 of the gas turbine airfoil at a shallow angle of about 30° relative to the external surface of the platform. It has been determined that holes drilled at the approximate 30° angle provide the best film cooling performance, and that holes drilled at an angle in excess of 30° result in degraded film cooling performance. As also shown in the dotted-line cavity configuration 22 in FIG. 2, a worst-case core float condition in the manufacture of the bucket, combined with positional tolerances of the drilled film cooling holes, may cause the drill bit 24 to miss the relocated target cavity 22 partially if not completely, so that the cooling hole may continue past the cavity into the shank or root portion 14 of the bucket. This is typically accounted for either by increasing the film cooling hole angle, or moving the film cooling hole closer to the slash face 17 of the airfoil platform 16. As also already noted, neither of these two options is particularly desirable.

In accordance with an exemplary but non-limiting embodiment of the invention, and with reference now to FIG. 3, a curved film cooling hole 30, represented schematically by an Electrical Discharge Machining (EDM) wire used to form the hole, is drilled through the platform 16 to the cavity 18, or 22) and the curvature of the hole allows the platform film cooling layouts to be located closer to the original design intent without neglecting manufacturing considerations. Note that the curved hole 30 can have a uniform or non-uniform radius of curvature, and/or part of the hole closest the platform could be straight and the remainder curved. In an example embodiment, the hole 30 can be formed such that the hole angle becomes steeper as the drill bit approaches the target cavity 18 (or 22), so that it is less likely that a the hole will partially or completely miss the target cooling cavity. In other words, the cooling hole may have a shallower angle (for example, 30° or less and preferably about 26°) where it exits onto the platform external surface than where it opens into the cavity 18 (or 20) within or radially inward of the platform. Thus, the hole exit point at the external surface of the platform 16 can be maintained at approximately 30° degrees to thereby retain maximum cooling performance, while the angle of the cooling hole entry point into the cavity may be e.g., >30°<90° relative to the internal cavity surface 32.

In the exemplary embodiment, the curved film cooling holes 30 may be drilled utilizing, for example, any conventional precision and high-speed wire EDM machines. Suitable EDM machines are available from, for example, Aerospace Techniques of Middletown, Conn., but others are available as well.

Other methods to drill curved holes include STEM (shaped-tube electrochemical machining), in which a curved electrode is rotated into the part to create a curved hole typically of constant radius but also of non-constant radii of curvature. Other ECM (electrochemical machining) or combination of methods could be used to form the hole in either a single or multiple processes.

It will be appreciated that many such film cooling holes 30 may be formed in any desired pattern to effectively film cool the bucket platform 16. The holes 30 may have diameters of about 0.03″, but the diameter may vary depending on specific applications.

in an exemplary embodiment, the platform end of the hole (or hole exit point) and the internal cavity end of the hole (or hole entry point) are determined and then the EDM or ECM machine is utilized to drill the hole at a uniform or non-uniform radius of curvature to insure that the hole or passage terminates well within the cavity 18 (or 22).

As indicated above, the invention is applicable in the drilling of cooling holes in the airfoil platform, the airfoil itself, or in any other component where film cooling hole configuration and location are critical.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A turbine bucket comprising:
an airfoil portion at one end thereof; a root portion at an opposite end thereof; a platform portion between said airfoil portion and said root portion; at least one internal cavity within or radially inward of said platform portion having at least one film cooling hole extending between said at least one internal cavity and an external surface of said platform portion, said at least one film cooling hole being curved along a length dimension of said at least one film cooling hole.

2. The turbine bucket of claim 1 wherein said at least one film cooling hole is formed with a non-uniform radius of curvature.

3. The turbine bucket of claim 1 wherein said at least one film cooling hole is formed with a substantially uniform radius of curvature.

4. The turbine bucket of claim 1 wherein said at least one film cooling hole intersects said external surface of said platform portion at an angle of less than about 30° relative to said external surface.

5. The turbine bucket of claim 4 wherein said at least one film cooling hole intersects said internal cavity at an angle greater than about 30° relative to an internal surface of said cavity.

6. The turbine bucket of claim 1 wherein said at least one film cooling exits at said platform at an angle shallower than an angle at which said cooling hole enters said internal cavity.

7. The turbine component of claim 1 wherein said at least one film cooling hole has a diameter of about 0.03″.

8. A turbine component comprising:
an external surface adapted to be cooled by film cooling air; an internal cavity within said turbine component adapted to supply film cooling air to said external surface; and at least one film cooling hole extending substantially radially between said internal cavity and said external surface, said at least one film cooling hole being curved along a length dimension of said film cooling hole, wherein said at least one film cooling hole opens along a surface of said external surface at an angle of less than about 30° relative to said external surface, and wherein said at least one film cooling hole opens along a surface of said internal cavity at an angle greater than about 30° relative to said surface of said internal cavity.

9. The turbine component of claim 8 wherein said at least one film cooling hole is formed with a non-uniform radius of curvature.

10. The turbine component of claim 8 wherein said at least one film cooling hole is formed with a substantially uniform radius of curvature.

11. The turbine component of claim 8 wherein said at least one film cooling hole intersects said external surface of said turbine component at an angle of about 26° relative to said external surface.

12. The turbine component of claim 11 wherein said at least one film cooling hole intersects said internal cavity at an angle greater than about 30° relative to an internal surface of said cavity.

13. The turbine component of claim 8 wherein said at least one film cooling hole has a diameter of about 0.03″.

14. A method of forming a film cooling hole in a turbine bucket platform connecting an external surface of the platform to an internal cavity within or radially inward of the platform comprising:
a. locating a film cooling hole exit point on an exterior surface of said platform and a film cooling hole entry point opening into said internal cavity; and
b. drilling said film cooling hole to follow a curved path between said film cooling hole exit point and said film cooling hole entry point.

15. The method of claim 14 wherein said arcuate path is based on a uniform radius of curvature.

16. The method of claim 14 wherein said arcuate path is based on a non-uniform radius of curvature.

17. The method of claim 14 wherein step (b) is carried out by electrical discharge machining.

18. The method of claim 14 wherein step (b) is carried out by electrochemical machining.

19. The method of claim 14 wherein said film cooling hole has a diameter of about 0.03″.

20. The method of claim 14 wherein said film cooling hole intersects said external surface of said platform at said exit point at an angle of less than about 30° relative to said external surface.

21. The method of claim 20 wherein said film cooling hole intersects an internal surface of said internal cavity at said entry point at an angle greater than about 30° relative to said internal surface.
